(19) United States
(12) Patent Application Publication
(10) Pub. No.: US 2009/0164191 A1
(43) Pub. Date: Jun. 25, 2009

(54) SIMULATION

(75) Inventors: Vincent Danos, Edinburgh (GB); Jean Krivine, Paris (FR)

Correspondence Address: PROSKAUER ROSE LLP, ONE INTERNATIONAL PLACE, BOSTON, MA, 02110, US

(73) Assignee: Plectix Biosystems, Inc., Cambridge, MA (US)

(21) Appl. No.: 12/180,272

(22) Filed: Jul. 25, 2008

Related U.S. Application Data
(60) Provisional application No. 60/952,518, filed on Jul. 27, 2007.

(51) Int. Cl. G06N 7/08; G06N 7/00; G06G 7/48

(52) U.S. Cl. 703/11; 706/59

(57) ABSTRACT

Identifying a set of rules, each of which, when executed, modify an agent in a model of a physical system. Identifying a causal map among the rules. Identifying a probability distribution on the set of the rules based on the causal map. Identifying a rule based on the probability distribution. Applying the rule to the physical system, thereby changing a state of the model of the physical system.

### RELATED APPLICATION

This application claims the benefit of priority under 35 U.S.C. §119 to U.S. provisional application 60/952,518, filed Jul. 27, 2007, the entirety of which is incorporated by reference herein.

### BACKGROUND

Modeling is a way to study a physical or virtual system. One way to model a system involves agent-based modeling. An agent is a logical structure that interacts with other agents according to rules of the model. When one or more agents interact, the model is said to evolve. The definition of the agents and rules are selected so that the model evolves in a way that parallels the evolution of the modeled physical or virtual system.

One way to simulate the evolution of a model is to select one or more agents at random, and to select a rule (if any) that determines the outcome of an interaction among the selected agents. Conversely, one may also select a rule at random and find agents (if any) that are in a condition to interact according to the selected rule.

This approach to modeling may be inefficient for some models. For example, if, for a given rule, there are relatively few agents to which the given rule applies, then finding such agents may be computationally expensive. Similarly, if, for a given set of agents, there are relatively few rules that apply to the given set of agents, then finding such rules may also be computationally expensive.

In some cases, rules specify patterns or conditions on agents that must be satisfied for the rules to apply. The simulation of a model based on such rules can become inefficient if its implementation requires the set of agents and their combinations at a given point in time to be expanded into the set of agents and their combinations that are possible in principle given the rules of the system. For example, the set of agent combinations possible in principle could be infinite. Our implementation detailed below can avoid these or other inefficiencies.

### SUMMARY

In general, in one aspect: identifying a set of rules, each of which, when executed, modify an agent in a physical system. Also identifying a causal map among the rules, updating a probability distribution on the set of the rules based on the causal map, identifying a rule based on the probability distribution; and applying the rule to the physical system, thereby changing a state of the physical system. Implementations may have one or more of the following features. The causal map includes a rule activation map. The causal map includes a rule inhibition map. The probability distribution is such that a probability with which a rule R is identified is proportional to a case count of the rule. A computational cost per rule application is independent of a total number of agents in the system. A computational cost per rule application is independent of a number of possible combinations of agents implied by the rules. A computational cost per rule application is bounded by a degree of a node on the causal map corresponding to the applied rule. Also including: identifying a first set of parameters; using the rules and the first set of parameters, simulating the evolution of the physical system; identifying a second set of parameters; and using the rules and the second set of parameters, simulating the evolution of the physical system. Also including identifying a possible application of the identified rule on a complex-by-complex basis, where each rule includes a left hand side describing a complex. The physical system includes a receptor. The physical system includes an epidermal growth factor (EGFR) receptor. The agent represents one of the group consisting of: a receptor, a scaffold, a signaling protein, a signaling component, a promoter, a gene, a segment of DNA. The agent includes a site, and at least one of the rules, when executed, modifies a value of the site. The site represents one of the group consisting of: an interaction capability, a DNA region, an amino acid, a surface characteristic. The value of the site represents one of the group consisting of: a binding occurrence at the site, or a modification of the site. The modification of the site includes one of the group consisting of: phosphorylation, dephosphorylation, ubiquitination, glycosylation, methylation. Also including designing an experiment based on the identified rules and the state of the model. Also including selecting a reagent based on the identified rules and the state of the model. Also including designing a pharmaceutical product based on the identified rules and the state of the model.

Other aspects include other combinations of the features recited above and other features, expressed as methods, apparatus, systems, computer-readable media, program products, and in other ways. Other features and advantages will be apparent from the description and from the claims.

### DESCRIPTION

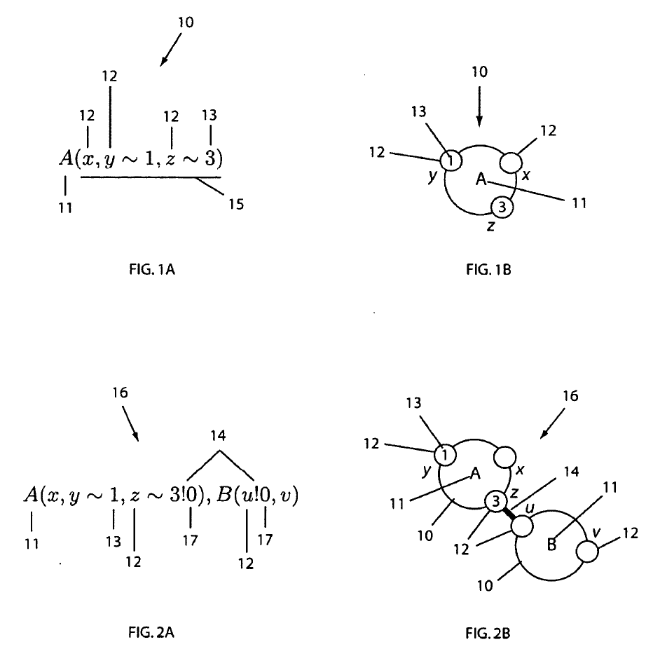

FIGS. 1A-B are schematic depictions of agents.

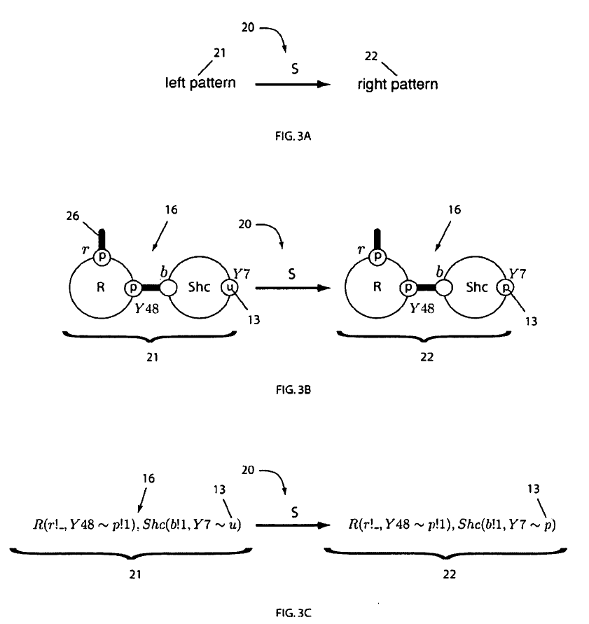

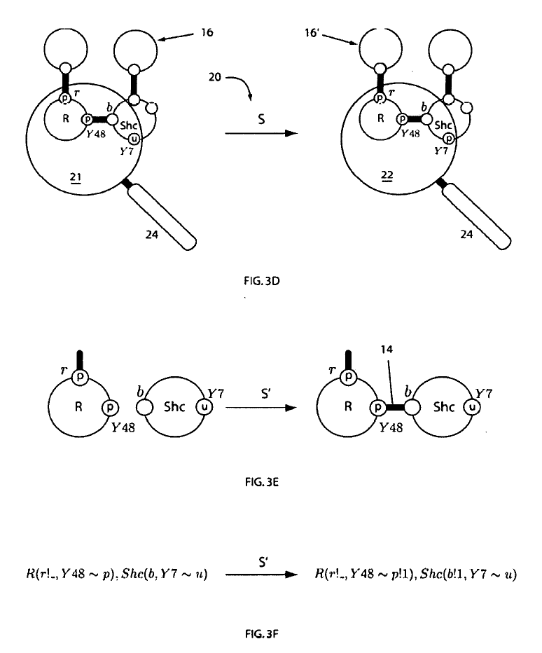

FIGS. 2A-B are schematic depictions of complexes.

FIGS. 3A-F are schematic depictions of rules.

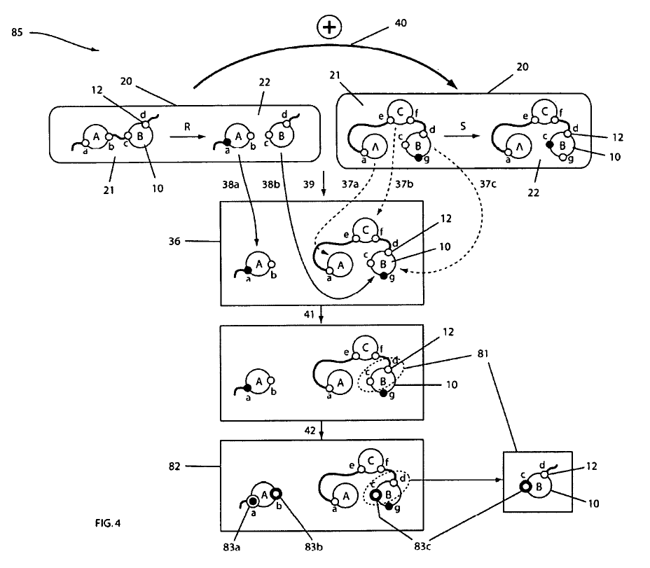

FIGS. 4-6 are schematic depictions of causal maps.

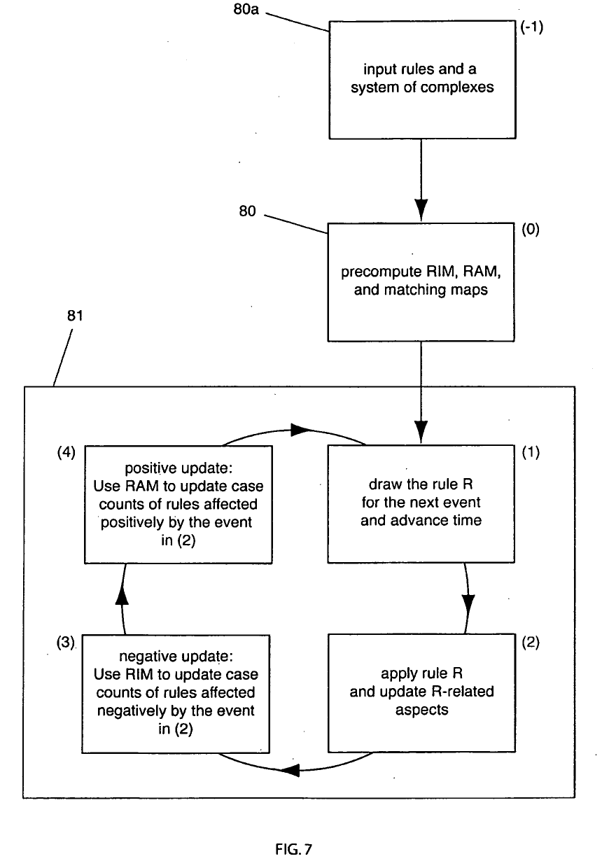

FIG. 7 is a flowchart for simulating using an agent-based model.

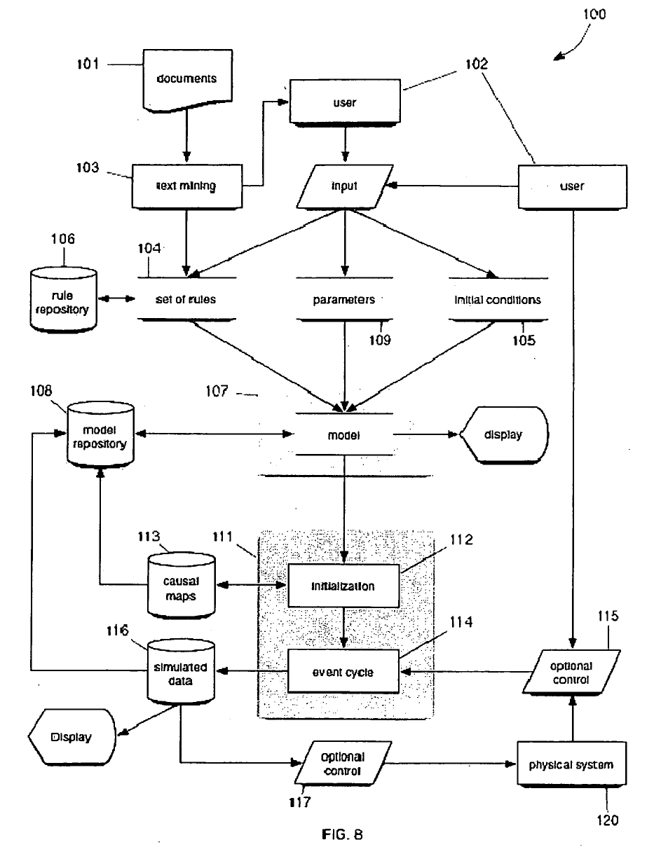

FIG. 8 is a block diagram for a simulation system.

FIG. 9 is a block diagram of a hardware implementation of a simulation system.

This document describes techniques for the simulation of agents that modify each other or interact with one another as specified by rules. As described further below, the rules prescribe manners in which the state of a system of agents can be updated by application of one or more rules.

The techniques described below allow for scale-invariant simulation. Scale invariance means that the computational cost of each update cycle of the simulation is independent of the number of agents in the system, the number of potential agent states implied by the rules, and is typically at most logarithmic in the number of rules. Scale invariance is typically desirable for the simulation of very large systems of agents.

Referring to FIGS. 1A-B, agents 10 can be expressed in terms of a formal language. In one language, shown in FIG. 1A, an exemplary agent 10 is specified by a name 11 and a set of labeled sites 12 constituting the agent's interface 15. Each site has a state 13 whose value ranges over a set. In some implementations, if no value is specified, the state assumes a default value.

The exemplary agent 10 of FIG. 1A has a name 11 of A. Agent A has three sites 12: x, y, and z. For a particular site 12, a state 13 is specified by following the site label by the “˜” (tilde) character, followed by the value of state 13. Thus, the sites y and z possess states 1 and 3, respectively, while site x has no specified state (or default value).

Referring to FIG. 1B, an agent 10 can also be expressed graphically. For example, in FIG. 1B the exemplary agent 10 of FIG. 1A is expressed as a shaded circle labeled with the name 11 of the agent. Sites 12 of the agent 10 are represented as smaller circles. For a particular site 12, a state 13 (if any is specified) is represented by a value within the smaller circle representing the site. The particular geometric elements (i.e., circles) are arbitrary choices, and other geometric elements (e.g., polygons, closed curves, etc.) could be used to denote the various components of an agent 10.

Among other things, an agent 10 can represent a component of a biological system. For example, the component can include an organism (e.g., a mammal, a bacterium, etc.), an anatomical structure (e.g., an organ or other group of cells), a cellular structure (e.g., a single cell, a sub-cellular component, etc.), a microscopic structure (e.g., any molecule such as a protein, a hormone, an amino acid, water, etc.) A site 12 of an agent 10 can represent a way for one agent 10 to interface with another.

For example, in a model of signaling events associated with the stimulation of a receptor, such as the epidermal growth factor receptor (EGFR), an agent 10 may represent a receptor, a scaffold, or any signaling protein or component (kinase, phosphatase, etc.) involved in the transduction of the signal. An agent 10 may also represent a segment of DNA, such as a promoter or a gene. A site 12 can represent any interaction capability, such as conveyed by a protein domain, a DNA region, an amino acid at a given position in the sequence of a protein, or a surface characteristic of the protein. A state 13 associated with a site 12 may represent, for example, that a protein is bound to a particular other protein (see below), or that the site has been modified by some post-translational modification, such as a phosphorylation, dephosphorylation, ubiquitination, glycosylation, methylation, etc. In the context of, for example, molecular signaling processes underlying cellular behaviors agents typically comprise proteins and other signaling components (such as hormones, or second messengers) that interact with one another through binding reactions, thereby forming complexes, or modification reactions, thereby altering each other's state. Rules specify conditions (for example, on the binding state or modification state of agent sites) that permit a combination of agents to act in a particular manner. A rule is typically a formal representation of an empirical fact, such as the observation of a particular mechanism of action. A rule may also represent a hypothesis about a mechanism of action. A collection of such rules constitutes a formal representation of the facts that define a model of interest of, for example, a signal transduction pathway (such as EGFR, mTOR, Wnt, IGF, etc.) or cellular process (such as cell division, repair, gene expression, etc.). The procedures described below detail how to efficiently simulate the evolution of a pathway or cellular process that is governed by a collection of rules. This can lead to an understanding of how a system behaves under normal conditions, disease conditions, or treatment conditions, and can lead to the more efficient design of experiments, choice of reagents, or design of pharmaceutical products.

Referring to FIGS. 2A-B, a site 12 can also be bound to a site 12 of an agent 10 (either a different agent 10 or itself) via a link 14. In FIG. 2A, exemplary agents A and B are expressed. Agent A has three sites 12, labeled x, y, and z; agent B has two sites, labeled u and v. In this representation, a link 14 is represented using the notation “!” followed by a token 17. The token 17 can be any character or string, and is chosen to be unique to the particular link 14 connecting the two sites 12. In the exemplary agents 10 of FIG. 2A, for example, there is a single link (between site z of agent A and site u of agent B), using the token “0.” Referring to FIG. 2B, the agents A and B of FIG. 2A are shown graphically. The link 14 is shown as an edge connecting the linked sites 12.

Agents that are bound to each other via links are called complexes 16. A complex is a connected graph whose nodes are agents and whose edges specify the sites through which the agents in the complex are linked with one another. Agents and complexes are included in the terms of the language. In what follows an agent is also referred to as a complex (consisting of one node).

Referring to FIG. 3A, rules 20 are specifications for rewriting terms of the language. A rule 20 includes a left hand side 21 and a right side 22, each of which includes a pattern. The left hand side 21 is separated from the right hand side 22 by an arrow. The rule may be labeled, e.g., by using a label above the arrow.

A pattern is a specification or partial specification of complexes 16. A pattern need not specify all the sites of an agent 10 in a complex 16. Furthermore, the pattern may specify partial links 26. A partial link 26 names an agent 10 and a site 12 through which the agent 10 is linked to an unspecified other agent 10. The unspecified other agent may include the agent 10 that is specified in the partial link 26.

The right hand side 22 of a rule 20 specifies a pattern that, when the rule is applied, replaces the left hand side 21 in a context that matches the latter. A match takes into account the names 11 of agents 10, the labels of sites 12, their states 13, and their link status (e.g., part of a link 14 or not part of a link 14). In this way, the left hand side 21 of a rule 20 specifies conditions to be satisfied in a concrete complex 16 before the rule 20 can be applied. Upon application of the rule 20, the portion of the complex 16 that matches the left hand side 21 is rewritten with the right hand side 22.

FIGS. 3B-C depict an example of a rule 20 expressed graphically (FIG. 3B) and textually (FIG. 3C) in one implementation of the language. The rule 20 includes a left-hand-side pattern 21 consisting of two linked agents R and Shc with sites 12 and their states 13 as indicated in the figure, and a partial link on site r of agent R. The right hand side 22 of rule 20 consists of the same linked agents, except that the state 13 of the site Y7 has a value p. Thus, the exemplary rule 20 describes the action of the rule to consist in changing the state of site Y7 from value u to value p.

Referring to FIG. 3D, the application of the rule 20 of FIGS. 3B-C to a complex 16 is schematically illustrated. It is first determined whether the complex 16 (or a portion of complex 16) matches the pattern on the left hand side 21 of the rule 20. In FIG. 3D, the portion of the complex 16 within the “lens” 24 matches the pattern on the left hand side 21. Thus, the rule 20 is applied to the portion of the complex 16 in the lens 24, resulting in a new complex 16′, which differs from the previous complex 16 only in the state 13 of the site 12 labeled Y7.

Referring to FIG. 3E, another rule 20 is shown. This rule 20 represents linking the R and the Shc complexes as shown. In FIG. 3F, the exemplary rule of FIG. 3E is shown in a formal language.

A Monte Carlo simulation of a system of complexes 16 interacting according to a set of rules 10 involves the repeated application of rules from the set according to appropriately calculated probabilities. An instance of the application of a given rule R to the system is referred to as an R-event. According to the techniques describes below, the probability that a given rule 20 is chosen for application depends on the number of potential application instances of the rule in a given system. This number is the number of cases that match the left hand side 21 of the rule 20 and is referred to as the “case count” of the rule. In some implementations, the application of a rule 20 changes the system's content by modifying, erasing, or creating complexes 16. Consequently, the probability distribution for choosing a particular rule 20 for the next interaction event is updated. In some implementations, the probability distribution is updated after each rule application.

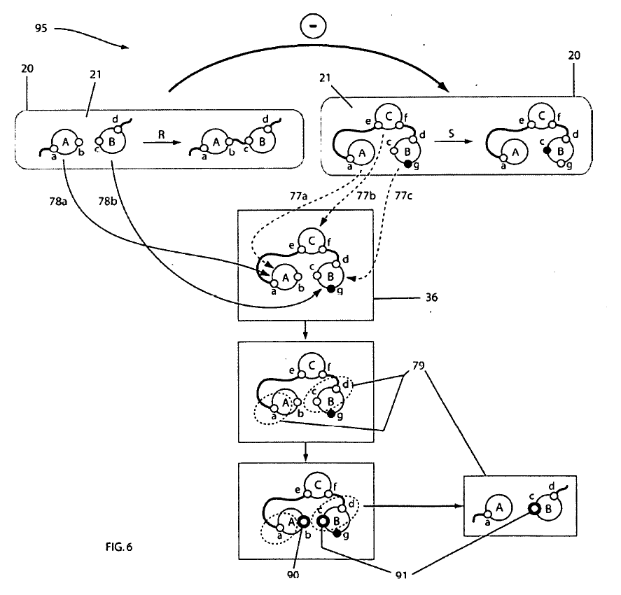

The update accounts for which rules 20 have lost potential application instances (their case count has decreased) and which rules have won new instances (their case count has increased). In some implementations, the update is performed using a causal map; i.e., a structure that describes whether an application of a rule 20 can affect the case count of another rule. A causal map may include a rule activation map (“RAM”) 85 (see FIG. 4) that describes whether an application of a rule can increases the case counts of other rules. A causal map may also include a rule inhibition map (“RIM”) 95 (see FIG. 6) that describes whether an application of a rule decreases the case counts of other rules. The RAM 85 associates with each rule R a set of rules whose case count may have increased as a consequence of the application of R. Conversely, the RAM 85 lists which rules cannot possibly have been affected by an R-event, thus making an update of their case count unnecessary.

FIG. 4 illustrates, in one implementation of the language, how it can be determined whether the application of a rule 20 has the potential of increasing the case count of another rule. In the example that follows, the rule R has been applied to the system, and the question is whether the application of the rule R can affect (i.e., increase) the case count of another rule S.

The first step 39 is to compute a pushout 36 of the right hand side 22 of the rule R and the left hand side 21 of the rule S. In some implementations, this can be done by generating the union of the two patterns and applying the following inclusion map: an agent in a pattern is mapped to an agent in the union if the agents have the same name and if they agree in the state and link status (e.g., linked or unlinked) of each site they both mention.

Thus, in the example of FIG. 4, the agent B in the right hand side 22 of rule R maps to the same agent as the agent B in the left hand side 21 of rule S, as indicated by the broken arrow 37c and the solid arrow 38b. The agent A in the right hand side 22 of rule R does not map to the agent A in the left hand side 21 of rule S, since both agents mention site a, but disagree on the state of site a. The solid arrows 38a and 38b show the inclusion map from the right hand side 22 of rule R into the pushout 36. Likewise, the broken arrows 37a, 37b, and 37c show the inclusion map for the left hand side 21 pattern of S.

The second step 41 identifies the intersection 81 of the images of the two inclusion maps 37, 38 in the pushout 36. The intersection 81 consists of the specification (perhaps partial) of agents 10 common to the right and left patterns of rules R and S, respectively.

The third step 42 checks whether this intersection 81 includes a site 12 that has been modified by the action of rule R. In drawing 82, there are three such sites (83a, 83b, and 83c). Site c of agent B (site 83c) is in the above mentioned intersection. In this example, rule R therefore activates rule S, meaning that the application of R in the system may cause an increase in the case count of S. Therefore, in the case of an R-event in a particular system, the update cycle of the simulator checks whether the case count of rule S has increased.

Referring to FIG. 4, in some implementations, the RAM 85 includes a directed graph whose nodes are rules 20. A directed edge 40 from rule R to rule S indicates that rule R activates rule S. Since the RAM 85 is an unchanging property of the rules defined at the outset of a simulation, the RAM needs to be computed only once, i.e. during the initialization phase of the simulation. Once computed, the RAM can be stored, e.g. on a data storage device, from which it can be read and processed at a later time by a program, e.g. should a user wish to execute another simulation involving the same rule set but different initial conditions and/or parameters.

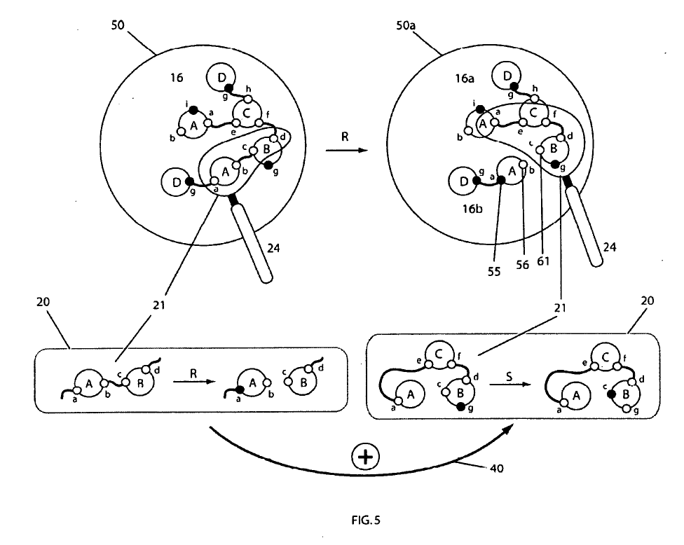

Referring to FIG. 5, an exemplary usage of the RAM 85 in the context of a system 50 is shown. The system 50 is symbolized as a circle 50, containing a collection of complexes 16. A sample complex 16 is drawn inside the system 50 to indicate its presence amongst other complexes (not shown). The left hand side 21 of exemplary rule R matches complex 16, as indicated by the lens 24 symbolizing the match. The action of rule R on complex 16 results in complexes 16a and 16b, evolving the system 50 into the system 50a.

The sites 55, 56, and 61 in system 50a were modified as a result of this R-event. The R-event activates a (possibly empty) set of rules 20; namely the set of rules sharing an edge 40 with R in the RAM 85. In FIG. 5, for example, one such rule 20 is rule S, since the new complex 50a contains a match for the left hand side 21 of rule S, as symbolized by the corresponding lens 24. It is seen how the embedding of the left hand side 21 of rule S in complex 16a includes a site 61 modified by rule R.

Referring to FIG. 6, like the RAM, a “rule inhibition map” or RIM 95 is a directed graph whose nodes are rules 20. A directed edge from rule R to rule S indicates that rule S may have its case count decreased as a consequence of an R-event. The procedure for establishing the RIM 95 is analogous to the procedure for establishing the RAM 85, except that the pushout 36 is now generated between the left hand side 21 of rule R and the left hand side 21 of rule S. In FIG. 6, exemplary rule R is a rule whose left hand side 21 includes two partial specifications of complexes 16. The pushout 36 is shown along with the inclusion map (77a, 77b, 77c) from the left hand side 21 of rule S and the inclusion map (78a, 78b) from the left hand side 21 of rule R. As before, the intersection of the two inclusion maps consists in the partial specification of agents common to both patterns. Finally, the sites 90 and 91 that will be modified by the action of R are checked for membership in the intersection 79. If, as is the case in this example, a site that will be modified by R is contained in the intersection of the inclusion maps associated with the pushout 36, rule R inhibits rule S, since rule R competes for matches with rule S in a collection of complexes 16 and an R-event destroys a match for S.

Referring to FIG. 7, one implementation of the techniques described above for simulating a system of complexes 16 evolving through the repeated application of rules 20 involves several phases.

The setup phase 80a includes identifying a set S of rules. Rules 20 may be written by one or more users to represent facts, e.g., about agent interactions extracted from the literature, databases, or from any other source. Rules may include hypotheses about agent interactions that the user entertains. In some implementations, rules may be automatically extracted from databases or generated automatically eusing text mining programs that scan the literature. In some implementations, the set S of rules 20 is read from a file that has been prepared by the user or has been generated automatically by procedures like the ones listed above. In some implementations, rules are supplied through a graphical interface enabling a user to express rules in a graphical representation that includes forms like those shown in FIG. 3B, 3E, or 5.

The setup phase 80a also includes identifying parameters for the simulation, such as rate constants associated with the rules. In some implementations, the parameters include environmental parameters (e.g., ambient temperature, pH, radiation flux, compartments, etc.).

The setup phase 80a includes the specification of initial complexes. In some implementations, the collection of initial complexes includes a quantity (e.g., a proportion or an absolute number) of each type of complex. In some implementations, each instance of a complex is represented in the memory of a computing device.

In the initialization phase 80, the rule activation map 85 and/or the rule inhibition map 95 are identified. For example, the maps 85 and/or 95 can be computed as described above, or supplied from another source.

In the initialization phase 80, for every rule R in S, a matching map (not shown) is identified that points to distinct matchings of the rule R's left hand side 21 in the collection of complexes 16. The size of the matching map is the case count of rule R. In some implementations, the matching map is used to compute the likelihood with which the rule R will be drawn to generate the next event in the event loop 81. In the event loop 81, a rule R is drawn from the set S of rules, according to a probability distribution on the set of rules S (step 1). In some implementations, this probability distribution may be a function of the case count of rule R in the current collection of complexes. For example, the probability with which a rule R is drawn may be directly proportional to its case count. Next, a matching of rule R is chosen from the matching map of R. In some implementations, the matching of rule R is chosen according to a probability distribution. For example, the probability distributions for choosing a matching may include the uniform distribution. The computational complexity of step 1 is of order log(|S|), where |S| is the number of rules in the rule set S.

The rule R is applied to the complex specified in the matching, thereby modifying the complex (step 2). R's matching map and its case count are updated (step 2). The computational complexity of step 2 is of the order of the size of the left pattern of the rule germane to that event.

For each rule Q pointed to by R in the RIM 95, the match that has disappeared as a consequence of R's application is erased from Q's matching map (step 3) and Q's case count is updated accordingly (step 3). The computational complexity of step 3 is of the order of the maximal out-degree of the RIM.

Similarly, for each rule Q pointed to by R in the RAM 85, each site modified by the action of R is checked whether it enables a new match for Q (step 4). If there is a new match, the matching map and the case count of Q are updated accordingly (step 4). The computational complexity of step 4 is of the order of the maximal out-degree of the RAM.

Steps 1-4 yield a simulation procedure whose computational cost per event is independent of the number of possible complexes implied by the rules and the initial condition. In addition, in some implementations, the computational cost per event is made independent of the size of the system (that is, the number of complexes that constitute the system at any given time) by an explicit representation of each instance of a complex in the system.

The RIM 95 and RAM 85 have a maximal out-degree, which is the largest number of rules influenced by the application of a rule from S. In some cases, this number is smaller than the size of the rule set S. Without the use of the RIM 95 or RAM 85, the corresponding updates (steps 3 and 4) may incur a computational cost that is linear in the size of the rule set, e.g., if every rule were checked for a change in its case count and matches. The dominant factor in the complexity of the updating step is, therefore, the logarithmic dependency on the size of the rule set S, which is inevitable whenever rules are chosen non-uniformly from a set.

The loop 81 can be stopped by pre-defined criteria. For example, such criteria may include the completion of a specified number of events (iterations of the cycle 81), the passage of a specified amount of simulated system time, the satisfaction of a statistical test on the system (for example, to establish equilibrium by monitoring the constancy of an average or the frequency of deviations of a given size), or the occurrence of a specified user condition, which includes the first application of a particular rule.

Various modifications are contemplated. For example, the above update phase 81 in which the RIM is computed can be replaced by augmenting the matching map constructed in 80 to become a bidirectional list. One direction points from a rule to all its matches in the collection of complexes (the system). In the other direction each matching in the collection of complexes lists all rules for which it is a matching. In this implementation, computation of the RIM 95 is not needed, since the negative update step 3 of the event loop 81 can follow the pointers from the matching that was altered by the R-event back to the rules whose case count is decreased. The matching is subsequently erased.

In another modification, the RAM 85 and/or RIM 95 are stored on a memory device, such as a disk, for reuse in subsequent simulations involving the same rule set S. Oftentimes a user may wish to run simulations with different initial conditions and/or parameters, but involving the same set of rules. Since the RAM 85 and RIM 95 express properties of the rule set, they can be reused.

In another modification, the update phase 81 is implemented using counters. In this implementation, the types of complexes in the system are represented explicitly and a counter is used to keep track of the number of instances of each type. In this case, the computational cost per event depends on the size of the system.

In another implementation, the update phase 81 does not build a map of matches for the entire left hand side of a rule. Rather, it builds a map of matches for each partial complex specification of the left hand side separately. In some cases, this implementation may save system resources, e.g. memory. For a rule having n partial specifications of complexes in its left hand side, the matching map for the entire left hand side would require a relatively large amount of memory, since every combination of matches with the partial complexes must be taken into account. For example, a rule with distinct first and second partial specifications of complexes that have X and Y matches in the system, respectively, requires memory for up to X*Y distinct matches for the full left pattern. In contrast, by storing the matches for each partial specifications of a complex separately (i.e., on a complex-by-complex basis) and drawing randomly from them to assemble a match for the left pattern only requires X+Y entries in the map. In this implementation, there is a possibility of a “clash”, that is, the drawing of two matches that overlap. When a clash occurs, the attempted reaction is a null-event and step 1 in the event loop 81 is repeated to draw a new rule. This procedure generates probabilistically correct draws.

The occurrence of a null-event requires a correction in advancing the simulated system time. The probability p(λ,f,T) that no event has occurred up to time T can be calculated using a recursion formula, e.g.,:

$$p ( λ , f , T ) = \frac{1}{F} {\sum }_{r ∈ R} f ( r ) p ( λ , f ( r ) - {δ}_{r} , T ) + {e}^{- λ T } \frac{{( λ T )}^{F}}{F !} ,$$

where λ is the total activity of the system as usually defined in the literature (by summing up the activities of each rule, which are proportional to the number of distinct matches each rule has in the system), f(r) is the number of clashes for rule r in the current event loop 81, and F is the total number of clashes in the current event loop. In typical implementations, clashes occur only rarely.

Referring to FIG. 8, a block diagram of a simulation system 100 is shown. The simulation system 100 may receive its input in several ways. In some implementations, text documents 101 are automatically processed with text mining software 103 to generate rules 20 that are added to a set of rules 104. In some implementations, one or more users 102 evaluate the output of the text mining software and change or refine rules 20 for addition to the set 104. In some implementations, one or more users 102 directly formulate rules 20 for addition to the set 104. The users 102 may interact with the simulation system 100 from a point outside the simulation system, e.g. over a network. In some implementations, the rules are read from a rule repository 106. The set of rules 104 constitutes a component of a model 107 of a physical system 120 (shown symbolically) that one wishes to simulate. Another component of a model 107 is given by a set of parameters 109 that users may associate with rules. A further major component of a model 107 is the specification of an initial composition 105 of the system to which the rules in the set 104 will be applied by the simulation engine 111. In some implementations the types of data 109 and 105 may be read from a data repository (not shown) that could include the rule repository 106. Once an appropriate model has been generated, it constitutes an asset that can be stored in a model repository 108 for future reuse. A model 107 can also be submitted to the simulation engine 111 directly from the repository 108.

The assembly of the model 107 and its input to the simulation engine 111 constitute the preparation phase 80a in FIG. 7. The initialization phase 112 of the simulation engine 111 corresponds to 80 (step 0) in FIG. 7. As explained in reference to FIG. 7, the initialization phase 112 may include the computation of the causal maps referred to as RIM 95 and RAM 85 by the procedures described above. The causal maps may be stored in a separate repository 113 for later reuse or they may be input to the initialization phase 112 from that store. The causal maps are a static property of the rule set 104 and may thus be stored along with the model 107 to which the rule set belongs.

The simulation engine 111 next enters the event cycle 114 described in detail in reference to FIG. 7 (steps 1-4). The event cycle is applied repeatedly to the model system causing it to evolve until a stopping criterion is met, as described in reference to FIG. 7. A control module 115 permits a user to alter the operating conditions of the cycle, such as parameters or system composition, while the simulation is running. In some implementations the control module 115 monitors the physical system 120 whose model 107 is being simulated, to control the simulation event cycle 114 based on events in the physical system 120. The simulation event cycle 114 continually generates data that may be stored in a storage device 116 or that may be displayed. The data reflect properties of the model and thus may be associated with the model in the repository 108 for later examination. Real-time analysis of the simulated data may trigger a control module 117 that affects the physical system 120, enabling a feedback between the rule-based simulation engine 111 and the physical system 120.

Referring to FIG. 9, a block diagram of an exemplary hardware implementation 200 of the simulation system 100 is shown. The exemplary hardware implementation 200 includes a processor 202, a data store 204, an input device 206 and an output device 208. The components 202-208 depicted in FIG. 9, their inter-connections, and their functions is shown by way of example only, and not meant to limit other implementations of the simulation system 100.

The processor 202 is configured to execute instructions, for example, instructions implementing steps described above. The processor 202 can include any commercial microprocessor. More than one processor 202 can be used. For example, more than one processor may be mounted on a single motherboard within the simulation system 100, or several processors 202, each on a distinct computer in mutual data communication, can serve as processors within the simulation system 100.

The data store 204 includes a computer-readable medium configured to store instructions to be executed by the processor 202. Additionally, the data store 204 is configured to store output of the executed instructions, for example quantities or relationships computed, determined, or identified in the course of performing steps described above. The computer-readable medium can be of any known type, including magnetic or optical media such as hard disks or CD ROM disks. The computer-readable medium can also include a solid-state device, such as volatile or non-volatile memory units. More than one computer-readable medium may be used in the data store 204. In some implementations, the data store includes at least one magnetic storage device and at least one memory chip.

The input device 206 is configured to receive information from a source outside the simulation system 100. The input device 206 may include, for example, a keyboard, mouse, microphone, video camera, scanner, touchscreen, etc. The input device 206 may also include a network device in data communication with a computer outside the simulation system 100 that is configured to read input transmitted from the computer outside the simulation system 100. The input can include, for example, data relevant to a simulation (e.g., rules, initial conditions, simulation parameters, stopping conditions, etc.) or commands to operate the simulation system 100 (e.g., begin a simulation, save the state of a simulation in progress, etc.)

The output device 208 is configured to transmit or display information from the simulation system 100 to a point outside the simulation system. Such information may include, for example, the status or result of a particular simulation. The output device 208 may include an audio or video display, a printer, or a network device configured to send information to a computer outside the simulation system 100.

The components 202-208 in the exemplary hardware implementation 200 are in mutual data communication. The data communication may be by direct physical connection (e.g. using fiberoptic or metallic wire); indirect physical connection (e.g. through other components such as bus or other components); wireless connection; etc.

Other embodiments are within the scope of the following claims.

What is claimed is:

1. A method comprising:
identifying a set of rules, each of which, when executed, modify an agent in a model of a physical system;
identifying a causal map among the rules;
identifying a probability distribution on the set of the rules based on the causal map;
identifying a rule based on the probability distribution; and
applying the rule to the physical system, thereby changing a state of the model of the physical system.

2. The method of claim 1 in which the causal map includes a rule activation map.

3. The method of claim 1 in which the causal map includes a rule inhibition map.

4. The method of claim 1 in which the probability distribution is such that a probability with which a rule R is identified is proportional to a case count of the rule.

5. The method of claim 1 in which a computational cost per rule application is independent of a total number of agents in the system.

6. The method of claim 1 in which a computational cost per rule application is independent of a number of possible combinations of agents implied by the rules.

7. The method of claim 1 in which a computational cost per rule application is bounded by a degree of a node on the causal map corresponding to the applied rule.

8. The method of claim 1, further comprising:
identifying a first set of parameters;
using the rules and the first set of parameters, simulating a first evolution of the physical system;
identifying a second set of parameters; and
using the rules and the second set of parameters, simulating a second evolution of the physical system.

9. The method of claim 1, in which each rule includes a left hand side, the left hand side describing complexes, the method further comprising identifying a possible application of the identified rule on a complex-by-complex basis.

10. The method of claim 1 in which the physical system includes a receptor.

11. The method of claim 10 in which the receptor includes an epidermal growth factor (EGFR) receptor.

12. The method of claim 1 in which the agent represents one of the group consisting of: a receptor, a scaffold, a signaling protein, a signaling component, a promoter, a gene, a segment of DNA.

13. The method of claim 1 in which the agent includes a site, and at least one of the rules, when executed, modifies a value of the site.

14. The method of claim 13 in which the site represents one of the group consisting of: an interaction capability, a DNA region, an amino acid, a surface characteristic.

15. The method of claim 13 in which the value of the site represents one of the group consisting of: a binding occurrence at the site, or a modification of the site.

16. The method of claim 15, in which the modification of the site includes one of the group consisting of: phosphorylation, dephosphorylation, ubiquitination, glycosylation, methylation.

17. The method of claim 1, further comprising designing an experiment based on the identified rules and the state of the model.

18. The method of claim 1, further comprising selecting a reagent based on the identified rules and the state of the model.

19. The method of claim 1, further comprising designing a pharmaceutical product based on the identified rules and the state of the model.

20. A computer readable medium bearing instructions to cause a computer to:
identify a set of rules, each of which, when executed, modify an agent in a physical system;
identify a causal map among the rules;
identify a probability distribution on the set of the rules based on the causal map;
identify a rule based on the probability distribution; and
apply the rule to the physical system, thereby changing a state of the physical system.

21. The computer readable medium of claim 20 in which the causal map includes a rule activation map.

22. The computer readable medium of claim 20 in which the causal map includes a rule inhibition map.

23. The computer readable medium of claim 20 in which the probability distribution is such that a probability with which a rule R is identified is proportional to a case count of the rule.

24. The computer readable medium of claim 20 in which a computational cost per rule application is independent of a total number of agents in the system.

25. The computer readable medium of claim 20 in which a computational cost per rule application is independent of a number of possible combinations of agents implied by the rules.

26. The computer readable medium of claim 20 in which a computational cost per rule application is bounded by a degree of a node on the causal map corresponding to the applied rule.

27. The computer readable medium of claim 20, further comprising instructions to cause a computer to:
identify a first set of parameters;
use the rules and the first set of parameters, simulate the evolution of the physical system;
identify a second set of parameters; and
use the rules and the second set of parameters, simulate the evolution of the physical system.

28. The computer readable medium of claim 20, in which each rule includes a left hand side, the left hand side describing complexes, the method further comprising identify a possible application of the identified rule on a complex-by-complex basis.
